(19) United States
(12) Patent Application Publication
(10) Pub. No.: US 2004/0263626 A1
(43) Pub. Date: Dec. 30, 2004

(54) On-line video production with selectable camera angles

(76) Inventor: Gregory A. Piccionelli, Westlake Village, CA (US)

Correspondence Address: Michael M. Gerardi, Esq., 28876 Woodcrest Lake Drive, Menifee, CA, 92584, US

(21) Appl. No.: 10/822,212

(22) Filed: Apr. 9, 2004

Related U.S. Application Data
(60) Provisional application No. 60/462,244, filed on Apr. 11, 2003.

(51) Int. Cl. H04N 7/18

(52) U.S. Cl. 348/157; 348/159; 348/143

(57) ABSTRACT

A system for on-line viewing of an event at an event site includes a central site connected to a network, and a plurality of cameras disposed about an event site. The cameras provide views of the event site from at least two different camera angles and provide video feeds to the central site via the network. Viewing means enable a user to access the central site and to selectively view the event site by means of at least two of the plurality of cameras. Methods of viewing the event, and systems and methods for recording the event so viewed, are also provided.

This application is based on Provisional U.S. Patent Application Ser. No. 60/462,244, filed Apr. 11, 2003, the entire disclosure of which is incorporated herein by reference.

### FIELD OF THE INVENTION

The present invention relates to a system and method of viewing an event via a network, such as the Internet, and to a system and method for recording the event so viewed. More particularly, the present invention relates to a system and method of producing a video recording in which an on-line user is enabled to selectably vary the camera angle used in producing the video recording.

### BACKGROUND OF THE INVENTION

Systems and methods that provide views of an event, such as a football game or other sporting event, a musical or dramatic performance, and the like, from multiple selectable angles are known. Typically, such systems include a plurality of cameras located at different sites around the playing field, stage, etc. Feeds from each camera are provided to a control room, and a production crew selects a sequence of feeds for broadcast to viewers.

Viewers of the events, however, must rely on the producers' selection of feeds. Some viewers may desire to view the event from an angle not selected by the producers. Presently known systems do not provide for an interactive viewing experience. In particular, presently known systems do not enable a viewer to select a desired sequence of camera angles and record them, more particularly to record them via a network such as the Internet.

Furthermore, presently known systems employ a large number of producers, directors, cameramen, grips and other technical personnel. The costs associated with such systems render broadcasting of events or productions to other than mass audiences prohibitively expensive.

A need exists for a system and method for viewing an event from a plurality of selectable camera angles.

A need also exists for a system and method of viewing an event over a network such as the Internet, and for recording the event so viewed.

### SUMMARY OF THE PREFERRED EMBODIMENTS

In accordance with one aspect of the present invention, there is provided a method of system for on-line viewing of an event at an event site. The system includes a central site connected to a network, for example the Internet; a plurality of cameras disposed about an event site, the cameras providing views of the event site from at least two different camera angles, the cameras providing video feeds to the central site via the network; and means enabling a user to access the central site and to selectively view the event site by means of at least two of the plurality of cameras.

In accordance with another aspect of the present invention, there is provided a system for on-line recording of an event at an event site. The system includes the central site, cameras and means for accessing the central site as described above, and further includes means for sequentially recording the feeds from the at least two of the plurality of cameras.

In accordance with a further aspect of the present invention, there is provided a method for on-line viewing of an event at an event site. According to the inventive method, a user first accesses via a network a central site connected to the network. The central site is connected via the network with a plurality of cameras disposed about an event site. The cameras provide views of the event site from at least two different camera angles, and provide video feeds to the central site via the network. The user then selectively views the event site by means of at least two of the plurality of cameras.

According to yet another aspect of the present invention, there is provided a method for on-line recording of an event at an event site. The method includes the steps described above for viewing the event, and further includes the step of sequentially recording the feeds from the at least two of the plurality of cameras.

Other objects, features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which

FIG. 1 is a schematic of a system according to the invention including a plurality of cameras disposed in a room about an event site, the cameras being connected to a central site via a network and providing video feeds to the central site, and

FIG. 2 is a flowchart illustrating a recording method according to the invention.

### DETAILED DESCRIPTION OF THE PREFERRED EMBODIMENTS

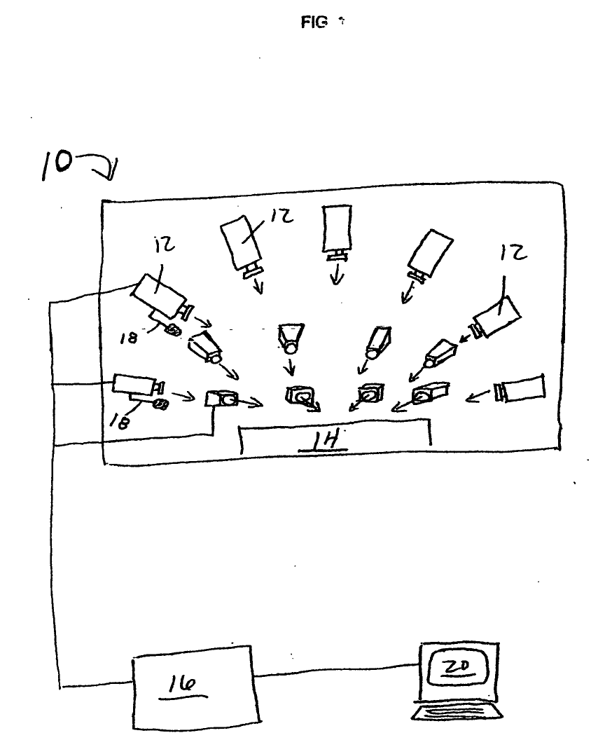

Referring to FIG. 1, a system 10 according to an embodiment of the invention includes a plurality of cameras 12 surrounding an event site 14 at which an event which is to be recorded takes place. Each camera 12 provides a video feed to a central site 16 which is accessible via a network such as the Internet.

In particular embodiments, each of the plurality of cameras 12 records the event taking place at event site 14 from a different angle. Cameras 12 can be distributed about event site 14 in any desired pattern. The configuration of the event site 14 will in certain embodiments constrain the distribution of cameras 12 for optimal coverage. For example, event site 14 in certain embodiments is a set within a sound stage at a film studio at which a performance takes place. Cameras 12 in such embodiments can be distributed in a regular hemispherical configuration, with each camera's field of vision overlapping to an equal degree such that the entire hemisphere is covered. If desired, a lesser number of cameras 12 can be employed, such that less than the entire hemisphere is covered but such that multiple camera angles are afforded. In such embodiments, the distribution of cameras 12 can be varied to emphasize desired ranges of camera angle. Alternatively, the cameras 12 can be distributed such that the field of vision of two or more cameras overlap to a greater degree than the remaining cameras.

In other embodiments, event site 14 is a stadium or other venue at which a sporting event, concert, political rally or other event takes place. Cameras 12 in such embodiments can be distributed around the periphery of the stadium or other venue, such that the event is visible from a desired range of camera angles. In more specific embodiments, cameras 12 are distributed about the entire periphery of the stadium or other venue, affording an approximately 360° view of the event. In still other embodiments, one or more cameras 12 can also be disposed at points within the stadium, for example along one or more sidelines of a football stadium, one or more baselines of a baseball stadium, adjacent a stage located within the stadium, etc. In additional embodiments, cameras 12 can be disposed at a plurality of locations along a parade route, highway, coastline or other extended geographic location.

In still other particular embodiments, cameras 12 are distributed at a plurality of locations on the outer surface of an aircraft, motor vehicle, naval vessel or other form of transportation. Such embodiments afford a range of landscapes, seascapes and/or aerial views observable during the course of travel by the aircraft or other form of transportation.

Cameras 12 in further particular embodiments can be accompanied by audio pickups 18, in order to provide sounds as well as images from each camera location.

A user accesses central site 16 via a personal computer, PDA or other device 20 that is capable of connecting to the network.

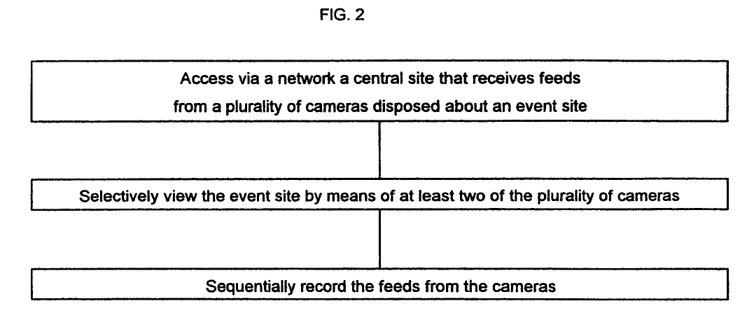

FIG. 2 illustrates an embodiment of a method of on-line video production according to the invention. Central site 16 receives feeds from the cameras 12 and makes the feeds available to a user. A user accesses central site 16 via a network, such as the Internet. In particular embodiments, the user subscribes to a service provided by the central site. In other particular embodiments, the user provides payment to the central site on a per-use basis, using a credit card or other conventional forms of payment.

Once the user accesses the central site, the user is afforded a selection of views of the event site. In particular embodiments, the user specifies one of the plurality of cameras 12 for viewing the event site 14, and then is enabled to sequentially or randomly access each of the other cameras 12. The user is thus enabled to view the event site 14 from one, some or all of the camera angles provided by the cameras 12. This allows the user to navigate around the event site 14 and view the events taking place therein from any desired camera angle(s).

Various means can be employed to enable the user to navigate around the event site 14. In particular embodiments, the user is provided with a menu listing all available cameras 12. By clicking on the desired camera, the user views the event site from the desired camera angle. In other embodiments, the menu can include a sequential cycling choice. Selection of this option provides a view of the event site from each camera angle in turn. Still other embodiments can include a random selection option. This option provides a sequence of views from randomly selected cameras.

Still other embodiments enable the user to access desired camera views by means of a joystick. Other control means, such as heads-up displays, can also be used to specify the particular view or views which the user desires to see.

The plurality of cameras 12 provide multiple camera angles from which to view the event site 14. Shifting from one camera to another provides a discrete change of camera angle. In specific embodiments, a continuous change of camera angle is provided. Such embodiments employ a processor to generate a smooth transitional view between two cameras.

More particular embodiments of the inventive method afford the user the option of recording the events as viewed. In specific embodiments, the user is provided with a menu option requesting that all selected and/or generated views of the event site be recorded. Such a recording can be prepared by the central site as a digital file which the user can subsequently download, or alternatively can be recorded at the central site on a computer disk, video tape, CAROM or any other desired storage medium and later provided to the user.

After recording the event as viewed, additional particular embodiments of the inventive method afford the user the option of editing the recording prior to downloading or transfer to a disk or other storage medium. For example, the user can be provided with the option of deleting one or more scenes as recorded by a particular camera 12; removing a selected segment of the recording; adding special effects to a selected segment, such as graphic overlays, sound effects, coloration, etc., enlarging one or more segments of the recording, thus simulating a close-up, and the like.

What is claimed is:

1. A system for on-line viewing of an event at an event site, the system comprising:
a) a central site connected to a network,
b) a plurality of cameras disposed about an event site, the cameras providing views of the event site from at least two different camera angles, the cameras providing video feeds to the central site via the network, and
c) means enabling a user to access the central site and to selectively view the event site by means of at least two of the plurality of cameras.

2. A system for on-line recording of an event at an event site, the system comprising:
a) a central site connected to a network,
b) a plurality of cameras disposed about an event site, the cameras providing views of the event site from at least two different camera angles, the cameras providing video feeds to the central site via the network,
c) means enabling a user to access the central site and to selectively view the event site by means of at least two of the plurality of cameras, and
d) means for sequentially recording the feeds from the at least two of the plurality of cameras.

3. A method for on-line viewing of an event at an event site, the method comprising the steps of:
a) accessing via a network a central site connected to the network, the central site being connected via the network with a plurality of cameras disposed about an event site, the cameras providing views of the event site from at least two different camera angles, the cameras providing video feeds to the central site via the network, and
b) selectively viewing the event site by means of at least two of the plurality of cameras.

4. A method for on-line recording of an event at an event site, the method comprising the steps of:
a) accessing via a network a central site connected to the network, the central site being connected via the network to a plurality of cameras disposed about an event site, the cameras providing views of the event site from at least two different camera angles, the cameras providing video feeds to the central site via the network,
b) selectively viewing the event site by means of at least two of the plurality of cameras, and
c) sequentially recording the feeds from the at least two of the plurality of cameras.
